(19) United States
(12) Patent Application Publication
(10) Pub. No.: US 2025/0194856 A1
(43) Pub. Date: Jun. 19, 2025

(54) AN OUTDOOR COOKING DEVICE

(71) Applicant: Doc Konto Ltd., Edgware (GB)

(72) Inventor: Alexander Kontoghiorghes, London (GB)

(21) Appl. No.: 18/846,934

(22) PCT Filed: Mar. 15, 2023
(86) PCT No.: PCT/GB2023/050612

§ 371 Date: Sep. 13, 2024

(30) Foreign Application Priority Data
Mar. 15, 2022 (GB) 2203548.9
Sep. 6, 2022 (GB) 2212982.9

(51) Int. Cl. A47J 37/07; A47J 36/32; A47J 37/04

(52) U.S. Cl. CPC A47J 37/0713; A47J 36/32; A47J 37/041; A47J 37/0745; A47J 37/0786; A47J 2202/00

(57) ABSTRACT

An outdoor cooking device such as a barbeque is described. It has a cooking section and a support to elevate the cooking section. It has one or more heating elements, at least one food holder, having a spindle, at least one sensor and at least one motor. The sensor comprises measuring means configured to weigh a corresponding one of the plurality of food holders and/or measure thickness of food that is held thereby. A controller is provided (locally or in combination with a wireless handset) to control the motor(s) to turn the spindle of the food holder based on a weight of the food holder and/or thickness of the food.

### FIELD OF THE INVENTION

The present invention relates to an outdoor cooking device; more particularly but not exclusively a barbecue.

### BACKGROUND

Many people in many societies enjoy outdoor eating in increasing numbers, and in increasing numbers of situations, particularly as the climate increasingly allows it.

However as the climatic conditions can be increasingly unpredictable, many such eating situations may be compromised or difficult to manage.

For this reason, as well as the demanding time and effort required to cook outdoors, it may be impossible or undesirable for a cook to remain with the outdoor cooking equipment over a prolonged period.

As a result, it may be desirable to obtain the benefits and experience of outdoor cooking without being continually required to monitor cooking conditions, for example turning foodstuffs to ensure even cooking.

### PRIOR ART

EP 2 082 475 (HECKER et al) discloses a rotisserie cooking device for use with a cooking source comprising: a food holding member; at least one motor operatively linked with the food holding member; at least one thermopile associated with the motor, the at least one thermopile providing energy for driving the at least one motor for rotating the food holding member.

CN 109 917 713 (HOU) discloses a wireless intelligent controller used for a barbecue oven and a control method thereof. The controller comprises a micro-control unit, a storage unit, a power supply unit, an external input unit, an external driving unit, an external measuring unit, an alarm unit, and a wireless unit, wherein the storage unit, the power supply unit, the external input unit, the external driving unit, the external measuring unit, the alarm unit, and the wireless unit are connected to the micro-control unit. The storage unit is connected to a display unit. The external driving unit is connected to a motor, a fan and a heating rod of the barbecue oven. The external measuring unit is connected to a temperature probe in the oven. By using the control method of the invention, a biomass material can be burned in the barbecue.

US 2007 0 240 698 (HOLBROOK) discloses an accessory for a barbecue grill which automatically flips food over 180 degrees at desired intervals, and which allows the food to rest essentially on the existing grill rack surface when cooking. The system includes a food support rack, rack mounts, linkage, motor control and motor mount with a motor and an L-shaped drive shaft. The food support rack includes lower and upper racks of open mesh, with the food to be cooked placed therebetween. The rack mounts provide for rotatable movement of the food support rack and are located on an axis essentially coincident with one of the longitudinal edges of the food support rack.

WO2020/0157546 (REGAZZON) discloses equipment for grilling food.

US2019/0183286 (CHEN) discloses a rotary barbeque with a forward-reverse motor.

US2015/0027321 (YU) discloses a barbeque spit with a probe.

The present invention arose in order to overcome problems suffered by existing devices.

### SUMMARY OF THE INVENTION

According to the present invention there is provided an outdoor cooking device comprising: a cooking section and a support, the support arranged to elevate the cooking section; one or more heating elements; at least one food holder having a spindle; at least one sensor comprising measuring means configured to weigh and/or measure the thickness of food items; at least one motor; and a controller adapted to control the at least one motor to turn the spindle of the food holder based on a weight and/or thickness of the food that is held thereby.

Preferably there is a plurality of food holders, each having a spindle and one or more sensors comprising measuring means configured to weigh food items and/or measure their thickness. In some embodiments, the measuring means is configured to weigh one of the plurality of food holders and/or measure the thickness of the food therein. Preferably the transceiver is adapted to control the at least one motor to turn the spindle of a corresponding one of the plurality of food holders based on a weight of the corresponding one of the plurality of food holders and/or thickness of the food that is held thereby.

In some embodiments the one or more holders is displaceable from the cooking section, such that the holders may be more easily operated with foodstuffs, which may be emplaced in the holders at a different location, for example indoors in a kitchen.

The one or more food holders do not necessarily encase or clamp the food items. Food holders may include any food mounting means such as forks, skewers or the like.

In some embodiments the one or more holders comprises a hinged top plate on a hinge with two pivot pins at one end, secured to a lower plate at a sliding catch. In this way the holders may accommodate and clamp down over different depths of foodstuffs.

The heating elements are preferably gas burners, but other heat sources/fuel types can be used, for example but not limited to charcoal, electricity, and wood pieces.

In some embodiments the cooking device can except a displaceable tray to enable solid fuel such as charcoal or wood chips to be used

In some embodiments the device comprises a battery, which may advantageously enable the device to be self-contained and moveable.

In some embodiments the device comprises a thermoelectric generator. This may harvest energy from heat within the cooking section, and may therefore be envisaged to provide a trickle-charge for the battery.

In some embodiments the device burners comprise wirelessly enabled gas valves, such that the amount of heat applied to the foodstuffs may be controlled remotely.

In some embodiments the motors provide wirelessly controlled rotation, such that the speed and amount of rotation may be controlled remotely. In some embodiments the support includes a lid, so as to enclose the cooking section and prevent contamination or rain entry.

In some embodiments the support includes a cupboard for a gas canister. In this way the gas may be locally stored and the device more self-contained and moveable.

In some embodiments the support includes one or more food preparation surfaces for local food preparation or utensil storage, such as a shelf, and in some embodiments the support includes castor wheels so as to allow easy movement.

In some embodiments the device comprises three holders and it may be envisaged that the device comprises three local controls. In some embodiments the holders comprise stainless steel mesh.

In some embodiments the device comprises one or more temperature sensors. A sensor may be provided to measure the internal temperature of the barbeque. A further sensor may be provided in the form of a probe arranged to sense internal temperature of food held in a holder.

In some embodiments the device may comprise one or more video cameras, such that a remote user can monitor the cooking of the foodstuffs.

In some embodiments the device comprises one or more weighing means or weight sensing means, for example provided by a weight transducer to convert an input mechanical force such as load, weight, tension, compression, or pressure into an electrical output signal that can be measured, converted and standardised. Such weighing means may be adapted to weigh the food holders. There may be one or more such sensors for each food holder, e.g. on a spindle of the food holder, or one at each end of the spindle. For a given food holder, an average weight can be calculated, from measurements taken at each end.

In this way it may be envisaged that the food holders may be weighed with foodstuff items after the food holders have been attached. This in turn may be envisaged to be advantageously used to monitor item weight, and therefore the device may be enabled to adjust and temperature and/or rotation patterns accordingly.

The weighing means may be calibrated to zero weight when the food holders are empty.

As an alternative to, or in addition to, measuring weight, sensors can be provided to measure thickness of the food in the food holder(s). Thickness can be measured by the already mentioned video camera, a laser, a simple ruler type device on the attached preparation surface, or by the distance between the clamping plates.

In some embodiments the support includes a separate surface with sensors where food items can be weighed and/or their thickness measured. For example, the surface may contain an electric weighing device, and above the electronic weighing device a vertically aligned laser can calculate the distance between the laser and the food item which when subtracted by the total distance between the laser and the weighing device can determine the thickness of the food item. As an alternative, or in addition, a sliding gauge attached to a vertical rod above the weighing device can also be used to measure the thickness of the food item. In some embodiments the sensors send food weight and/or thickness information to the controller which then optimally sets the cooking temperature and rotation speed given the information.

Weight and/or thickness can be used to control the speed or frequency of rotation frequency of the food holder(s). Preferably, the heavier and/or thicker the food item, the slower and/or less frequently the food item is rotated. This advantageously reduces risk of burning of smaller items but improves localised surface grilling of larger items.

Weight and/or thickness can be used to control the temperature of the food item. Where the food items are heavier, the heating element (e.g. gas burner) can be automatically turned down, leading to lower temperature and vice-versa for lighter food items. For example, a large steak or cut of meat may require a lower temperature so that it is not burned on the outside and undercooked in the centre.

It can be envisaged that one motor can drive different spindles and control different food holders at different speeds or frequencies. This can be achieved mechanically through selective drive means to selectively apply the motor to different spindles. Preferably, there is one motor per spindle and each motor is controlled in speed or frequency of turning according to its respective weight and/or thickness.

In some embodiments all food holders are driven in unison by one or more motor so that rotation is synchronised. In other embodiments each food holder is separately controlled so that rotation speed and duration can be independently controlled. This may be achieved by a separate motor operatively connected to each holder, or by an arrangement of gearing and a clutch system so that rotation of each food holder can be selectively engaged thereby providing multiple cooking options.

In preferred embodiments the cooking tray is a substantially rectangular open top box wherein at least two opposed walls are adapted to receive and hold the food holders within the perimeters of the walls. For example the opposed walls may include apertures and/or channels for receiving the spindles and that enable the spindle to pass through the wall to engage with the motor, or a component driven by the motor, in order for the food holders to be turned.

It can be envisaged that one sensor can be used to measure weight and/or thickness of all the food items. For example, a video camera with machine vision software can be used to measure the thickness of each of several food items. Similarly, the machine vision software can measure volumes of food and convert these to weights. Each spindle can have its own corresponding measuring means.

It can be envisaged that the cooking device has a controller to operate the at least one motor and optionally other features of the cooking device. Typically the controller includes switches to turn on, off and to adjust the one or more heat sources and to turn on, off and to adjust the speed of one or more motors that rotates the at least one food holders. Preferably the switches are associated with a printed circuit board (PCB) that is connected to a power supply.

The controller ideally has a processor such as a microprocessor to receive, send and analyse signals received from one or more sensor that are on the cooking device or optionally remote sensors. In this way the controller monitors operation of the device and may adjust settings in response to data signals received.

In preferred embodiments the cooking temperature is monitored, and data signals received by a microprocessor associated with the controller, or a remote device, analyse the temperature and may adjust the heat sources and/or rotation of the foods on the food holders to achieve optimal cooking.

Preferably the controller provides signals to start and stop rotation of the food holders when a command signal is received, for example by turning a switch on or off or in response to a signal from a sensor or combination of signals from two or more sensors.

The controller may also enable the speed and duration of rotation to be controlled. For example a rotation programme may be enabled that has a fixed rotation rate and duration, preferably after the food item has been specified as well as its weight and/or thickness.

In some embodiments the controller may also be used to control the heat source, for example to start and stop cooking by turning on and off the one or more heat source.

In some embodiments the controller may be operatively connected to a control panel for manual operation by a user. In some embodiments the control panel includes a display to indicate status of the cooking device which may include various settings and parameters of the device such as temperature.

In some other embodiments the controller is adapted to receive wireless signals from, and transmit wireless signals to, a remote electronic device to enable operation of the cooking device. For example the controller may communicate with an electronic device, such as a smartphone so that a user can control operation remotely using an application on the electronic device.

In some embodiments that are wirelessly controlled there may be no control panel and instead a display may be provided to indicate the status of the cooking device that is controlled by a remove electronic device.

In devices that include means for remote, wireless operation the device may include a transceiver for receiving signals from and sending signals to the remote device and also for receiving data signals from sensors provided on the device. The signals are analysed by the processor and the controller initiates actions in response to certain conditions. For example rotation speed may alter as temperature changes.

It is appreciated that the controller and/or a remote device sending signals to the controller may be pre-programmed with cooking settings for particular foods, so that a pre-set programme can be initiated once the food has been added.

In this way heat sources, such as gas burners may have wirelessly enabled gas valves, so that the gas burners can be activated remotely by the controller so that the amount of heat applied to the foods may be controlled remotely. Ideally the programme is tailored to the food, for example taking into consideration type of food, weight of food, thickness of the food and how it is being cooked. These parameters may be used to calculate preferred temperature(s), duration of cooking and/or speed of rotation at different stages of cooking. In some embodiments the device may have sensors to analyse the food being cooked and select a programme to reflect this.

In yet further embodiments the device may be adapted to operate in response to voice commands. For example, the controller and/or the remote device in communication with the controller may include voice detection and interpretation means so that voice commands can be received and processed to control operation of the device. For example the user can use voice commands to instruct the device to switch on or off, specify the temperature, inform the device of the type(s) of food item(s), inform the device of the weight and/or thickness of the device, and inform the device to what degree they would like the food items cooked to, for example but not limited to rare, medium, well done, lightly charred, and charred. Advantageously this means a user does not need to touch the controls whilst handling food, thereby improving hygiene.

It is appreciated that for devices that are wirelessly enabled, the cooking device may be adapted to operate through various remote devices that can receive and transmit data signals to the cooking device. For example the cooking device may be synced with other household devices and networks, such as Amazon Echo Dot® or a Nest® system.

The cooking device has at least one power source to provide power to the at least one motor and other electrical components such as the controller. In some embodiments the device comprises a battery, which may advantageously enable the device to be self-contained and moveable. In other embodiments the device may have a cable for connection to a mains power supply.

In preferred embodiments the support includes a lid, so as to enclose the cooking section and fully define the cooking cavity, as well as to prevent contamination or rain entry.

In some embodiments the lid is provided on an automated hinge so that opening and closing of the lid is automated. For example the automated hinge may be controlled by means of a motor.

In another embodiment the automated lid may include one or more electromagnet to enable the lid to be released from a locked position and then moved from a first position to a second position. The hinge may include one or more dampener to prevent the lid from slamming closed.

Advantageously the automated lid may also be enabled remotely. This may help a user to handle foods and not have to also operate the lid. For example the user may use a voice command to open and close the lid, thereby only opening the lid when required, thereby conserving heat in the device.

In yet a further embodiment the device may include a water sensor to detect rainfall so that the lid automatically closes on detection of rain. In this way a user is able to leave the cooking device unattended outside but does not risk cooking being compromised.

In preferred embodiments the cooking device has at least one air vent to help regulate cooking temperature. Preferably the cooking vent is provided on a side edge of the cooking tray.

In some embodiments the at least one vent is automated so that opening or closing of the one or vent is in response to detection of one or more parameter, such as temperature in the cooking device, duration of cooking.

In some embodiments the at least one vent is wirelessly controlled so that a user can increase or decrease airflow from a remote location.

In some embodiments the cooking section is adapted to receive a griddle to enable cooking of other food above the food holders. In this way heat is not lost by first heating a griddle before heating the food holders.

In some embodiments the griddle may be set above the food holders at a level that permits rotation of the food holders so that rotation is not impinged in any way.

In other embodiments the griddle is provided at a lower level and rotation of the food holders is not permitted simultaneously with use of the griddle.

It is appreciated that in some embodiments it may be possible to set the griddle at two or more levels to provide different cooking options, both in respect of proximity of the griddle to the heat sources and with respect to rotation of the food holders. For example in some embodiments the food holders may be removed, and the griddle may be mounted on the same means used to secure the food holders, providing a lower cooking level. A second higher cooking level may be provided in which the griddle is arranged on a separate receiving means that is above the food holders.

The griddle may be a solid plate or may be slatted or a mesh or a combination thereof. In this way the griddle may be adapted for different types of cooking. For example in some embodiments the upper surface of the griddle is used to sear foods or to provide a stove top for a pan.

It is appreciated that different areas of the griddle may be indicated in relation to location of heat sources to enable temperature control.

In some embodiments the griddle may be arranged on a rotating base that also is driven by the at least one motor, or a second motor to facilitate even cooking.

In some embodiments the device may be adapted for indoor use, or appropriate ventilation may be provided indoors to enable the same device to be used indoors and outdoors.

According to a further aspect of the present invention there is provided software for controlling a device according to nay of the preceding claims comprises a means to set cooking models combining temperature, timing and rotation patterns.

A preferred embodiment of the invention will now be described by way of example only and with reference to the Figures in which:

### BRIEF DESCRIPTION OF FIGURES

FIG. 1 shows an isometric view of an embodiment of the device according to the present invention, with the support opened;

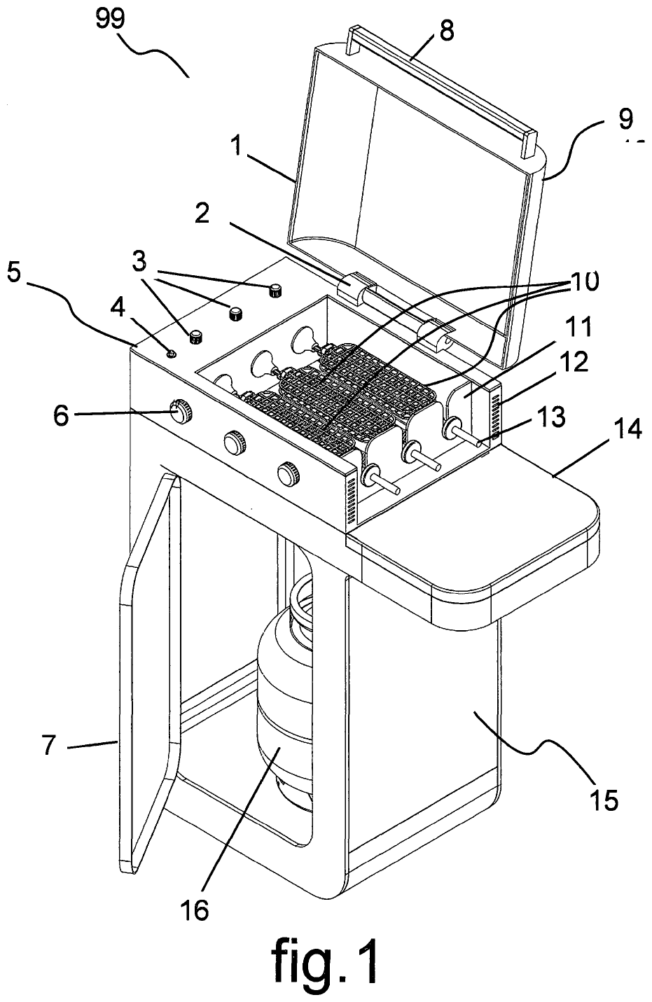

FIG. 2 shows a reverse isometric view of the embodiment of the device shown in FIG. 1;

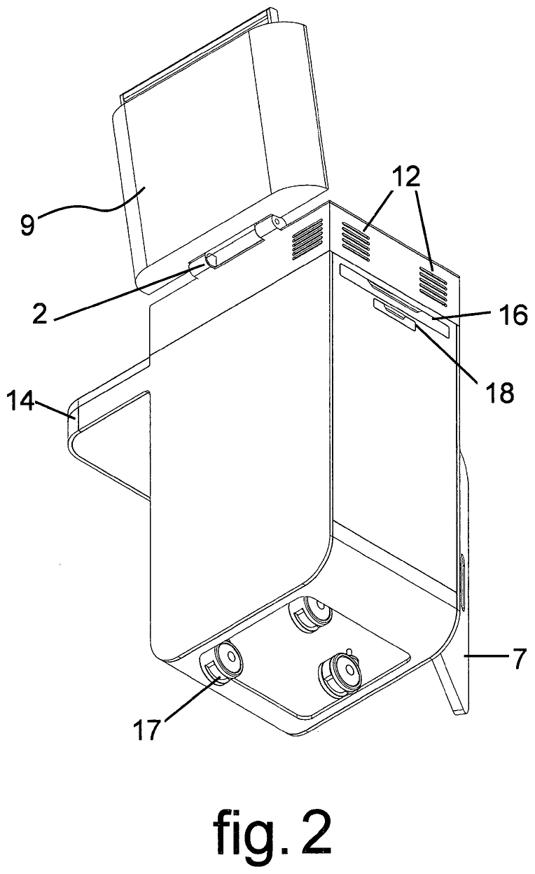

FIG. 3 shows an isometric view of an embodiment of the device shown in FIG. 1, with the support closed;

FIG. 4 shows a reverse isometric view of the embodiment of the device as shown in FIG. 3;

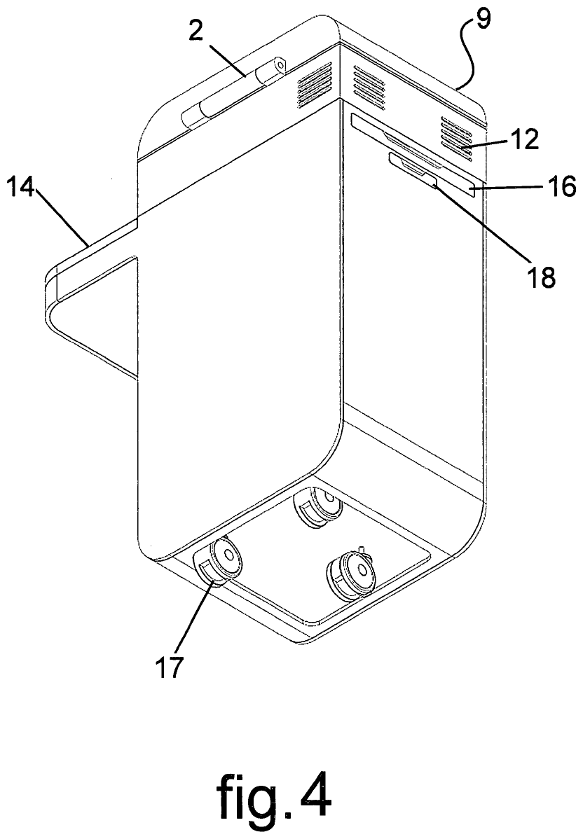

FIG. 5 shows an exploded isometric view of the embodiment of the device shown in FIG. 1; and

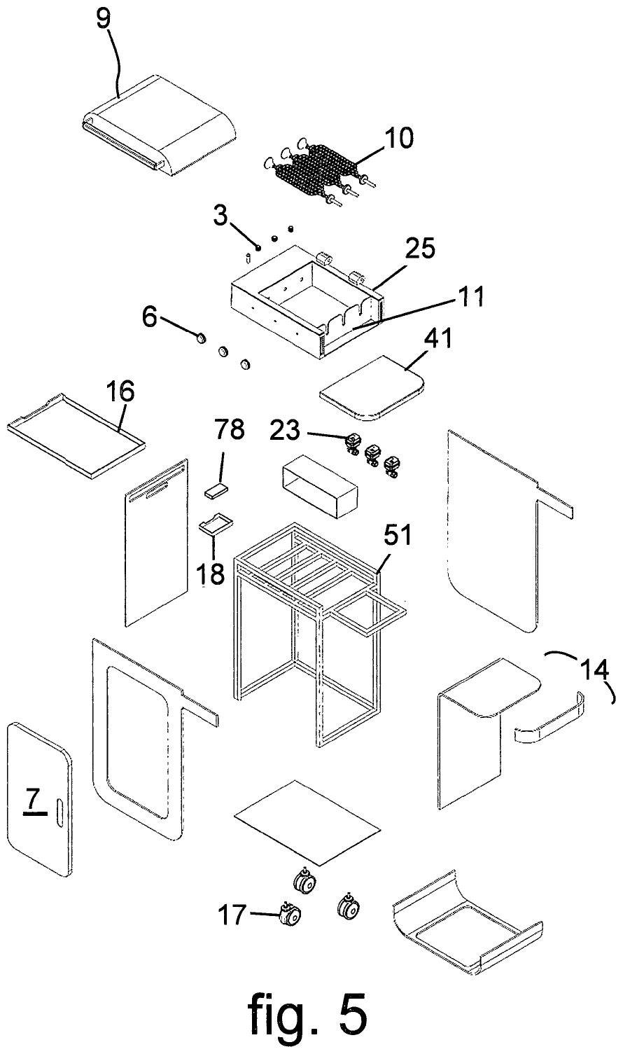

FIG. 6 shows a reverse exploded isometric view of the embodiment of the device shown in FIG. 1.

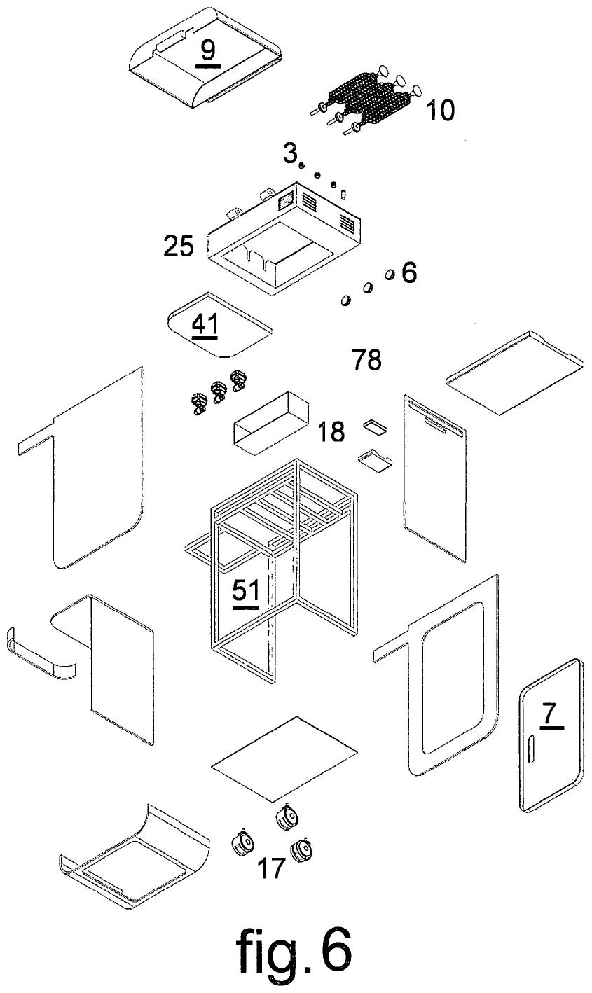

### DETAILED DESCRIPTION OF FIGURES

With reference to the figures there is shown an embodiment of an outdoor cooking device generally comprising: a cooking section 5 and a support 15, the support arranged to elevate the cooking section; one or more gas burners; a plurality of food holders 10; and motors 23; and a controller adapted to control the motors; wherein the holders comprise perforated clamping plates having endmost spindles, such that a motor turns the spindle.

In particular reference to the pictured embodiment the embodiment comprises a monolithic support 15, which supports the cooking section 5 on an upper location thereof.

The cooking section is rectangular in footprint and has a hinged lid 9, which is hinged at a hinge 2 along one long edge, and includes a handle 8 at the opposed long edge. The lid curves upwards to provide space under it.

The support 15 includes an internal skeleton 51 formed in mild steel and is clad with sheets of stainless steel or aluminium. A front face of the support provides a hinged door 7, for a cupboard to contain a gas canister in use, and whatever utensils.

A side face of the support provides a laterally extending food preparation area 14, which has a wooden or stone surface 41.

The support further includes castor wheels 17 to enable the movement of the device.

The cooking section comprises three spindles which support the holders 10. The holders comprise two perforated stainless steel plates, which are longitudinally arranged on the spindles and hinged at an end. The hinge comprises two vertically spaced hinge pins and rocker connector between the two pins, such that the holder plates can adjust for different depth foodstuffs, and the distal end of the holder includes a slidable ring to catch the top plate, and hold it under tension against the foodstuff and hinge.

The support includes a sliding grease collection tray 16, and a battery hatch 18, for receipt of batteries 78, which may be rechargeable or replaceable. It may be envisaged for example that the electronics are powered by a 12V LiPo battery which could be trickle-charged using the heat generated from the gas grill, or could be replaceable, and re-charged externally.

The cooking section cooking tray 25, which comprises a motor and control end and a support plate end 11. The control end includes a cooling fan (not shown) expelling hot air from internal the cooking section through vents 12, and a printed circuit board control (not shown). The three motors comprise 12V geared down motors driven by the battery or batteries.

The control end further comprise an ignition and three individual local speed controls 3 for the motors. The front of the cooking section comprises further local control means 6, namely three gas burners controls for heat control.

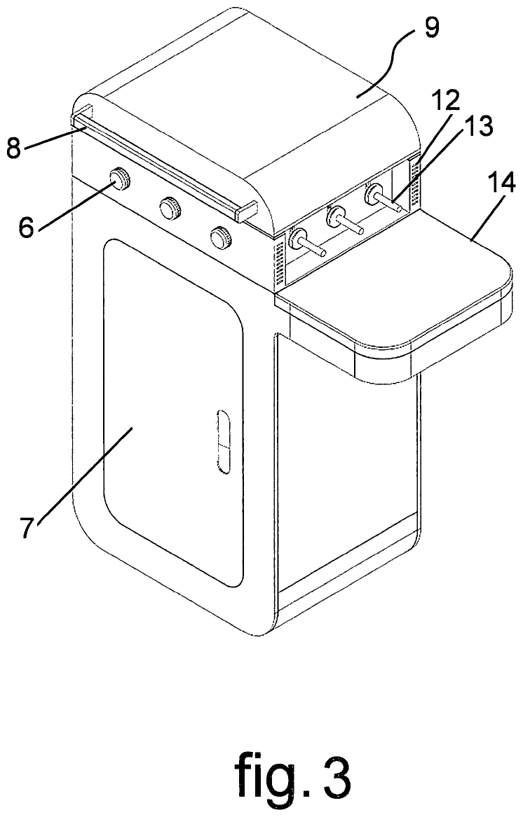

The support plate 11 has depending slots in its top edge, into which the distal ends of the spindles are dropped. When the lid 9 is closed, as shown in FIG. 3, the spindle ends 13 are still available for the user to turn them.

In use therefore the spindles are displaced from the cooking section, the holders are opened and the foodstuffs placed within them, then the top plate is closed down over the foodstuff and the ring catch at the distal located to hold the holder closed.

The proximal ends are located onto the motor at the control end and the distal ends into the slots.

The controller may take the form of a microcontroller in the cooking device, having software for controlling the motor(s) and heating element(s) to set cooking models combining temperature, timing and rotation patterns.

The controller may comprise a receiver in the cooking device adapted to receive wireless controls from a handset, e.g. an app on a mobile phone.

In the case of wireless control, the controller may comprise a pair of transceivers, one in the handset and one in the device controller.

Weight, thickness and/or temperature measurements sensed at the device can be sent to the handset, which may calculate appropriate cooking parameters (e.g. according to a type of food input at the handset) and the parameters (e.g. speed of rotation and temperature) are sent to the controller in the cooking device.

The user may be offered a choice of food items at the handset by food category (e.g. “chicken” or “steak”) and this may cause the handset to select different cooking parameters corresponding to the selected category and the received weight and/or thickness.

Alternatively, the handset transmits the food category selection to the cooking device and the microcontroller at the cooking device calculates the cooking parameters for that category and for the measured weight and/or thickness.

The invention has been described by way of examples only and it will be appreciated that variation may be made to the above-mentioned embodiments without departing from the scope of protection as defined by the claims.

1. An outdoor cooking device comprising:
a cooking section and a support, the support arranged to elevate the cooking section;
one or more heating elements;
at least one food holder, having a spindle;
at least one sensor comprising measuring means configured to weigh and/or measure thickness of food;
at least one motor; and
a controller adapted to control the at least one motor to turn the spindle of the food holder based on the weight and/or thickness of the food.

2. An outdoor cooking device according to claim 1, having: a plurality of food holders, each having a spindle; and one or more sensors comprising measuring means configured to weigh and/or measure the thickness of food items.

3. An outdoor cooking device according to claim 2, wherein the transceiver is adapted to control the at least one motor to turn the spindle of a corresponding one of the plurality of food holders based on a weight of the corresponding one of the plurality of food holders and/or thickness of the food that is held thereby.

4. An outdoor cooking device according to claim 1, wherein each of the one or more food holders is displaceable from the cooking section.

5. An outdoor cooking device according to claim 1, wherein each of the one or more food holders comprises a hinged top plate on a hinge with two pivot pins at one end, secured to a lower plate at a sliding catch.

6. An outdoor cooking device according to claim 1, comprising a battery to enable a self-contained device

7. An outdoor cooking device according to claim 1, comprising a thermoelectric generator.

8. An outdoor cooking device according to claim 1, wherein the burners include wirelessly enabled gas valves.

9. An outdoor cooking device according to claim 1, wherein the motors provide wirelessly controlled rotation or flipping.

10. An outdoor cooking device according to claim 1 wherein the support includes a lid.

11. An outdoor cooking device according to claim 1, wherein each food holder comprises perforated clamping plates having endmost spindles, such that a foodstuff is clamped between the plates.

12. An outdoor cooking device according to claim 11, wherein the holders comprises stainless steel mesh.

13. An outdoor cooking device according to claim 1, comprising three food holders and three speed controls.

14. An outdoor cooking device according to claim 1, wherein a temperature sensor is provided to sense the internal temperature of the outdoor cooking device.

15. An outdoor cooking device according to claim 1 wherein the at least one sensor comprises one or more video cameras, arranged such that a remote user can monitor the cooking of the foodstuffs.

16. An outdoor cooking device according to claim 1, wherein a probe is provided to sense internal temperature of food held in a holder.

17. An outdoor cooking device according to claim 1, wherein the controller is adapted to also control the cooking temperature of the food items based on the weight and/or thickness of the food items.

18. Software for controlling a device according to claim 1 comprising a means to set cooking models combining temperature, timing and rotation patterns.

19. A method of cooking with an outdoor cooking device having a cooking section with a support to elevate the cooking section, one or more gas burners, a plurality of food holders each having a spindle, a plurality of sensors, each sensor comprising weighing means configured to weigh a corresponding one of the plurality of food holders, and at least one motor, the method comprising:
controlling the at least one motor to turn the spindle of a corresponding one of the plurality of food holders based on a weight of the corresponding one of the plurality of food holders.

20. An outdoor cooking device comprising:
a cooking section and a support, the support arranged to elevate the cooking section;
one or more gas burners;
a plurality of food holders wherein each food holder comprises perforated clamping plates configured for clamping foodstuff therebetween and has endmost spindles;
a plurality of sensors, each sensor comprising a weighing means
configured to weigh a corresponding one of the plurality of food holders;
a plurality of motors; and
a transceiver adapted to control the plurality of motors to turn the spindle of a corresponding one of the plurality of food holders based on a weight of the corresponding one of the plurality of food holders.
